(19) United States
(12) Patent Application Publication
(10) Pub. No.: US 2013/0091909 A1
(43) Pub. Date: Apr. 18, 2013

(54) LOCK CYLINDER WITH JOGGLE JOINT STRUCTURE

(71) Applicant: Wen Kun LAI, GUANGDONG PROVINCE (CN)

(72) Inventor: Wen Kun LAI, GUANGDONG PROVINCE (CN)

(21) Appl. No.: 13/467,067

(22) Filed: May 9, 2012

(30) Foreign Application Priority Data
Oct. 13, 2011 (CN) 201110309802.7

(51) Int. Cl. E05B 15/12; E05B 15/14

(52) U.S. Cl. 70/379 R

(57) ABSTRACT

A lock cylinder with joggle joint structure comprising a plug and a casing. Key pins are disposed within the plug. Driver pins are disposed within the casing. Inner ends of the key pin and the driver pin engage with each other to form an integral locking member. A plurality of integral locking members are disposed in the lock cylinder. An outer end of the driver pin is disposed with a spring. The inner end of the key pin is disposed with a mortise, the inner end of the driver pin is disposed with a tenon, and so the key pin and the driver pin engage with each other in form of a joggle joint.

### BACKGROUND OF THE INVENTION

The present invention is a kind of lock cylinder, and more specifically a kind of lock cylinder with joggle joint structure.

Nowadays, lock cylinders are pin tumbler locks. Contact between key pins and driver pins of pin tumbler locks are point-contact or surface-contact. Point-contact or surface-contact is/are disadvantageous in that the part of contact is merely the mutual contact between points or surfaces. Therefore, the contact is very weak in strength, susceptible to lock picking under external force, and therefore poor at anti-theft performance.

### BRIEF SUMMARY OF THE INVENTION

In view of the aforesaid disadvantages now present in the prior art, the present invention provides a lock cylinder with joggle joint structure wherein the contact between key pins and driver pins is changed to joggle joint.

The above object is attained as follows: the lock cylinder with joggle joint structure comprises a plug and a casing. Key pins are disposed within the plug. Driver pins are disposed within the casing. Inner ends of the key pin and the driver pin engage with each other to form an integral locking member. A plurality of integral locking members are disposed in the lock cylinder. An outer end of the driver pin is disposed with a spring. It is characterized in that the inner end of the key pin is disposed with a mortise, the inner end of the driver pin is disposed with a tenon, and so the key pin and the driver pin engage with each other in form of a joggle joint. The key pin is provided with a step portion at a middle portion thereof. The step portion enables the key pin to be fixed at an inner edge of the plug. Another end of the key pin protrudes from the plug and is provided with a wedge slope at its end portion. A notch is provided at the wedge slope. The notches of the key pins are not identical to each other.

The mortises and the tenons have cross sections in H-shape, triangular shape, rectangular shape or trapezoidal shape.

The key pins and driver pins with joggle joint structure include a single-pin structure and a double-pin structure.

The present invention has the following beneficial effects: The present invention configures the connections between the driver pins and the key pins as joggle joints, thereby greatly enhances anti-theft, anti-picking and anti-pry performances.

### BRIEF DESCRIPTION OF THE DRAWINGS

FIG. 1 is a partial sectional view of the present invention;

FIG. 2 is a schematic view of a key pin and a driver pin;

FIG. 3 illustrates connection between a key pin and a driver pin;

Wherein,

1: plug

2: casing

3: key pin

4: driver pin

5: spring

6: mortise

7: tenon

8: step portion

9: inner edge

10: wedge slope

11: notch

### DETAILED DESCRIPTION OF THE INVENTION

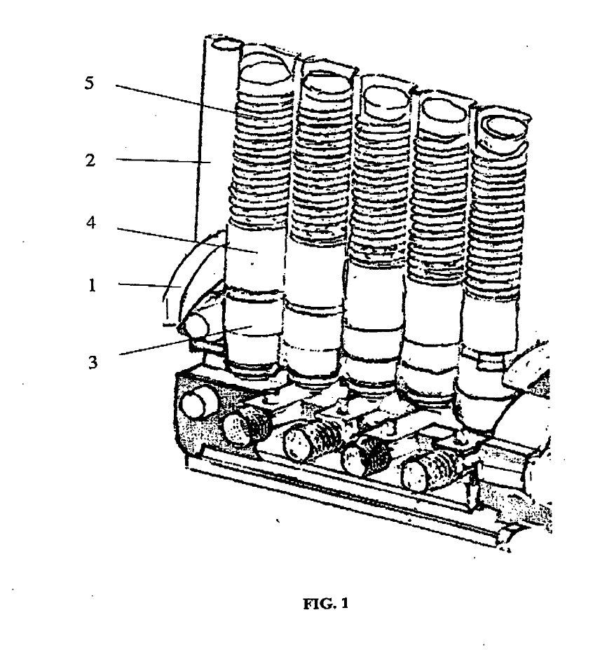

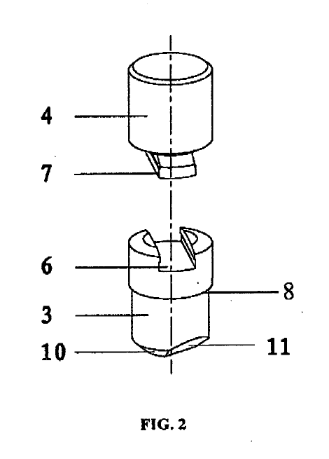

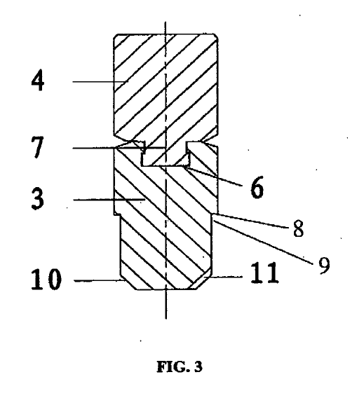

As shown in FIG. 1, FIG. 2 and FIG. 3, the lock cylinder with joggle joint structure comprises a plug 1 and a casing 2. Key pins 3 are disposed within the plug 1. Driver pins 4 are disposed within the casing 2. Inner ends of the key pin 3 and the driver pin 4 engage with each other to form an integral locking member. A plurality of integral locking members are disposed in the lock cylinder. An outer end of the driver pin 4 is disposed with a spring 5. It is characterized in that the inner end of the key pin 3 is disposed with a mortise 6, the inner end of the driver pin 4 is disposed with a tenon 7, and so the key pin 3 and the driver pin 4 engage with each other in form of a joggle joint. The key pin 3 is provided with a step portion 8 at a middle portion thereof. The step portion 8 enables the key pin 3 to be fixed at an inner edge 9 of the plug 1. Another end of the key pin 3 protrudes from the plug 1 and is provided with a wedge slope 10 at its end portion. A notch 11 is provided at the wedge slope 10. The notches 11 of the key pins 3 are not identical to each other.

The mortises 6 and the tenons 7 have cross sections in H-shape, triangular shape, rectangular shape or trapezoidal shape.

The key pins 3 and driver pins 4 with joggle joint structure include a single-pin structure and a double-pin structure.

When a key is entirely inserted into the lock cylinder, key bittings on the key are tightly engaged with the notches at end portions of the key pins, so that the integral locking members are forced to rotate in a way that the key and the joggle joint portions between the key pins and the driving pins form an angle of 90 degree, enabling the key to rotate. As the key rotates, the key pins are disengaged from the driver pins, locking mechanism is disabled and the lock is opened. When the key is rotated back to its original position and taken out, the key bittings on the key would then force the integral locking members to rotate back to their original positions in a reversed direction, where the joggle joint portions between the key pins and the driver pins no longer form a 90 degree. Accordingly, the lock is locked, and at this moment, the integral locking members could only move vertically. The plug is therefore fixed, the locking mechanism is enabled, and the lock cylinder could not be opened. Since the integral locking members with joggle joints are securely engaged to form as integral members and fix the plug, the lock cylinder has very good anti-opening, anti-tampering and anti-picking capabilities.

1. A lock cylinder with joggle joint structure, comprising a plug and a casing; key pins are disposed within the plug; driver pins are disposed within the casing; an inner end of each of the key pins and an inner end of each of the corresponding driver pins engage with each other to form an integral locking member wherein the inner end of each of the key pins faces respectively to respective corresponding driver pins and the inner end of each of the driver pins faces respectively to respective corresponding key pins; a plurality of integral locking members are disposed in the lock cylinder; an outer end of each of the driver pins is disposed with a spring; and characterized in that, the inner end of each of the key pins is disposed with a mortise, the inner end of each of the driver pins is disposed with a tenon, and so each of the key pins and each of the corresponding driver pins engage with each other in form of a joggle joint; each of the key pins is provided with a step portion at a middle portion thereof; a protruded edge is provided at the plug for each of the key pins: each of the protruded edge protrudes towards each of the key pins disposed within the plug and below the step portion of each of the key pins so that the step portion of each of the key pins rests on the respective protruded edge and the key pins are therefore held within the plug; contact end of each of the key pins contacting an unlocking key to be inserted into the lock cylinder protrudes from outer circumference of the plug: each of the key pins is provided with a wedge slope at the contact end which contacts the unlocking key and a notch at the wedge slope; the notches of the key pins disposed in the same locking cylinder are not identical to each other.

2. (canceled)

3. (canceled)
